(19) United States
(12) Patent Application Publication
(10) Pub. No.: US 2026/0158660 A1
(43) Pub. Date: Jun. 11, 2026

(54) SYSTEMS AND METHODS FOR CALIBRATING ROBOT ACTUATORS USING IMAGE DATA

(71) Applicant: Boston Dynamics, Inc., Waltham, MA (US)

(72) Inventor: Kyle W. Rogers, Carlisle, MA (US)

(21) Appl. No.: 18/975,766

(22) Filed: Dec. 10, 2024

(51) Int. Cl. B25J 9/16; B25J 13/08; G06T 7/73

(52) U.S. Cl. CPC B25J 9/1692; B25J 13/088; G06T 7/73; G06T 2200/04

(57) ABSTRACT

Method and apparatus for calibrating actuators of a robot using image data are provided. Image data is received from at least one sensor when a robot is in a pose, where a joint of the robot represented in the image data has an expected joint position when the robot is in the pose. Based on the image data, an actual joint position of the joint when the robot is in the pose is determined. When it is determined that the actual joint position of the joint is different from the expected joint position of the first joint, an encoder of an actuator associated with the joint is configured based, at least in part, on the actual joint position of the joint.

### TECHNICAL FIELD

This disclosure relates generally to robotics, and more specifically to systems, methods and apparatuses for calibrating robot actuators.

### BACKGROUND

A robot is generally defined as a reprogrammable and multifunctional manipulator designed to move material, parts, tools, and/or specialized devices through variable programmed motions to perform one or more tasks. Robots may be manipulators that are physically anchored (e.g., industrial robotic arms), mobile platforms that move throughout an environment (e.g., using legs, wheels, or traction-based mechanisms), or some combination of one or more manipulators and/or one or more mobile platforms. Robots are utilized in a variety of industries including, for example, manufacturing, warehouse logistics, transportation, hazardous environments, exploration, and healthcare.

### SUMMARY

Safe and accurate control of a robot may require knowledge about the absolute position of the robot's joints. In a typical design, a joint of the robot may include an input encoder and two output encoders. The input encoder may be configured to measure a rotor position of an actuator at the joint. Collectively the two output encoders may provide the absolute position of the joint with a first output encoder being configured to perform a function, such as moving the actuator by a degree of rotation based on a control instruction, and a second output encoder being configured to perform a diagnostic check on the rotor position. The inventors have recognized and appreciated that, because a rotor of an actuator may experience multiple rotations, the input encoder may only be able to track a change in position of the rotor rather than the absolute position of the rotor, which may require an initial calibration of the absolute rotor position upon system startup. The inventors have further recognized and appreciated that in a clutchless actuator design, an input encoder and an output encoder are rigidly coupled, such that the output encoder reading reliably follows the input encoder reading after the initial calibration upon system startup. Accordingly, it is possible to remove the second output encoder from the joint and still provide safe and accurate control of an actuator at the joint if an initial calibration of the input encoder of the actuator can be performed on startup using other information. To this end, some embodiments of the present disclosure relate to a mobile robot configured to use image data captured by one or more sensors to calibrate an input encoder of an actuator when the robot assumes a pose in which an associated joint has an expected position that can be observed in the image data.

In some embodiments, the invention features a method. The method includes receiving first image data from at least one sensor when a robot is in a first pose, wherein a first joint of the robot represented in the first image data has an expected joint position when the robot is in the first pose, determining, based on the first image data, an actual joint position of the first joint when the robot is in the first pose, and configuring a first encoder of a first actuator associated with the first joint based, at least in part, on the actual joint position of the first joint when it is determined that the actual joint position of the first joint is different from the expected joint position of the first joint.

In one aspect, the method further comprises receiving second image data from the at least one sensor when the robot is in a second pose, wherein a second joint of the robot represented in the second image data has an expected joint position when the robot is in the second pose, determining, based on the second image data, an actual joint position of the second joint when the robot is in the second pose, and configuring a second encoder of a second actuator associated with the second joint based, at least in part, on the actual joint position of the second joint when it is determined that the actual joint position of the second joint is different from the expected joint position of the second joint.

In another aspect, configuring the first encoder based, at least in part, on the actual joint position of the first joint comprises configuring the first encoder to scale an output of the first encoder by a scaling factor, the scaling factor being determined based on a difference between the actual joint position and the expected joint position.

In another aspect, the first image data comprises three-dimensional (3D) image data, and determining, based on the first image data, the actual joint position of the first joint when the robot is in the first pose comprises performing object detection to identify the first joint represented in the 3D image data, determining, using the 3D image data, a distance from the at least one sensor to the first joint, determining the actual joint position of the first joint when the robot is in the first pose based on the distance from the at least one sensor to the first joint. In another aspect, performing object detection to identify the first joint represented in the 3D image data comprises identifying a visually-identifiable feature on the robot, wherein the visually-identifiable feature is represented in the 3D image data and identifies the first joint. In another aspect, the visually-identifiable feature comprises a fiducial mark. In another aspect, the fiducial mark comprises an infrared reflector, a bump or a line on the robot.

In another aspect, a second joint of the robot represented in the first image data has an expected joint position when the robot is in the first pose, and the method further comprises determining, based on the first image data, an actual joint position of the second joint when the robot is in the first pose, and configuring a second encoder of a second actuator associated with the second joint based, at least in part, on the actual joint position of the second joint when it is determined that the actual joint position of the second joint is different from the expected joint position of the second joint. In another aspect, the first joint of the robot is coupled to a first member of the robot and the second joint of the robot is coupled to a second member of the robot, the second member not being coupled to the first joint of the robot.

In another aspect, the first joint of the robot is coupled to a first member of the robot and the second joint of the robot is coupled to the first member of the robot. In another aspect, the first member is a member of an arm or leg of the robot.

In another aspect, determining, based on the first image data, the actual joint position of the first joint and the actual joint position of the second joint comprises determining, based on the first image data, that the first joint is aligned with the second joint when the first joint is in the expected joint position, and determining the actual joint position of the second joint in response to determining that the first joint is aligned with the second joint. In another aspect, determining that the first joint is aligned with the second joint comprises determining that the first joint and the second joint are aligned in a straight line. In another aspect, determining, based on the first image data, that the first joint is aligned with the second joint when the first joint is in the expected joint position comprises identifying a first visually identifiable feature represented in the first image data, wherein the first visually identifiable feature identifies the first joint, identifying a second visually identifiable feature represented in the first image data, wherein the second visually identifiable feature identifies the second joint, and determining that the first joint is aligned with the second joint when the first visually identifiable feature and the second visually identifiable feature have a particular spatial relationship. In another aspect, the particular spatial relationship comprises a straight line from the first joint to the second joint.

In another aspect, a second joint of the robot represented in the first image data has an expected joint position when the robot is in the first pose, at least one member of the robot couples the first joint to the second joint, and the method further comprises determining an actual joint position of the second joint using the actual joint position of the first joint.

In another aspect, a second joint of the robot represented in the first image data has an expected joint position when the robot is in the first pose, at least one member of the robot couples the first joint to the second joint, and the method further comprises determining that a second encoder of a second actuator associated with the second joint is properly calibrated when it is determined that the actual joint position of the first joint matches the expected joint position of the first joint.

In another aspect, the method is performed as part of a start-up operation of the robot.

In another aspect, configuring the first encoder based, at least in part, on the actual joint position of the first joint when it is determined that the actual joint position of the first joint is different from the expected joint position of the first joint comprises after configuring the first encoder, receiving second image data from the at least one sensor when the robot is in a second pose, wherein the first joint of the robot represented in the second image data has an expected joint position when the robot is in the second pose, determining, based on the second image data, an actual joint position of the first joint when the robot is in the second pose, and determining that the first encoder is properly calibrated when it is determined that the actual joint position of the first joint when the robot is in the second pose matches the expected joint position of the first joint when the robot is in the second pose.

In another aspect, the at least one sensor includes a sensor coupled to the robot. In another aspect, the at least one sensor is included in a vision system of the robot. In another aspect, the vision system of the robot is included in a head of the robot.

In another aspect, the at least one sensor includes a sensor located in an environment of the robot.

In another aspect, the method further comprises outputting an indication that the robot may be operated safely when it is determined that the actual joint position matches the expected joint position. In another aspect, outputting an indication that the robot may be operated safely comprises controlling the robot to perform a first task.

In some embodiments, the invention features a robot. The robot includes a set of members, a set of joints coupling the set of members, and a controller configured to receive first image data from at least one sensor when the robot is in a first pose, wherein a first joint of the set of joints represented in the first image data has an expected joint position when the robot is in the first pose, determine, based on the first image data, an actual joint position of the first joint when the robot is in the first pose, and configure a first encoder of a first actuator associated with the first joint based, at least in part, on the actual joint position of the first joint when it is determined that the actual joint position of the first joint is different from the expected joint position of the first joint.

In one aspect, the controller is further configured to receive second image data from the at least one sensor when the robot is in a second pose, wherein a second joint of the set of joints represented in the second image data has an expected joint position when the robot is in the second pose, determine, based on the second image data, an actual joint position of the second joint when the robot is in the second pose, and configure a second encoder of a second actuator associated with the second joint based, at least in part, on the actual joint position of the second joint when it is determined that the actual joint position of the second joint is different from the expected joint position of the second joint.

In another aspect, configuring the first encoder based, at least in part, on the actual joint position of the first joint comprises configuring the first encoder to scale an output of the first encoder by a scaling factor, the scaling factor being determined based on a difference between the actual joint position and the expected joint position.

In another aspect, the first image data comprises three-dimensional (3D) image data and determining, based on the first image data, the actual joint position of the first joint when the robot is in the first pose comprises performing object detection to identify the first joint represented in the 3D image data, determining, using the 3D image data, a distance from the at least one sensor to the first joint, and determining the actual joint position of the first joint when the robot is in the first pose based on the distance from the at least one sensor to the first joint. In another aspect, performing object detection to identify the first joint represented in the 3D image data comprises identifying a visually-identifiable feature on the robot, wherein the visually-identifiable feature is represented in the 3D image data and identifies the first joint. In another aspect, the visually-identifiable feature comprises a fiducial mark. In another aspect, the fiducial mark comprises an infrared reflector, a bump, or a line on the robot.

In another aspect, a second joint of the set of joints represented in the first image data has an expected joint position when the robot is in the first pose, and the controller is further configured to determine, based on the first image data, an actual joint position of the second joint when the robot is in the first pose, and configure a second encoder of a second actuator associated with the second joint based, at least in part, on the actual joint position of the second joint when it is determined that the actual joint position of the second joint is different from the expected joint position of the second joint. In another aspect, the first joint is coupled to a first member of the set of members and the second joint is coupled to a second member of the set of members, the second member not being coupled to the first joint.

In another aspect, the first joint is coupled to a first member of the robot and the second joint is coupled to the first member of the robot. In another aspect, the first member is a member of an arm or a leg of the robot.

In another aspect, determining, based on the first image data, the actual joint position of the first joint and the actual joint position of the second joint comprises determining, based on the first image data, that the first joint is aligned with the second joint when the first joint is in the expected joint position, and determining the actual joint position of the second joint in response to determining that the first joint is aligned with the second joint. In another aspect, determining that the first joint is aligned with the second joint comprises determining that the first joint and the second joint are aligned in a straight line.

In another aspect, determining, based on the first image data, that the first joint is aligned with the second joint when the first joint is in the expected joint position comprises identifying a first visually identifiable feature represented in the first image data, wherein the first visually identifiable feature identifies the first joint, identifying a second visually identifiable feature represented in the first image data, wherein the second visually identifiable feature identifies the second joint, and determining that the first joint is aligned with the second joint when the first visually identifiable feature and the second visually identifiable feature have a particular spatial relationship. In another aspect, the particular spatial relationship comprises a straight line from the first joint to the second joint.

In another aspect, a second joint of the set of joints represented in the first image data has an expected joint position when the robot is in the first pose, at least one member of the set of members couples the first joint to the second joint, and the controller is further configured to determine an actual joint position of the second joint using the actual joint position of the first joint.

In another aspect, a second joint of the set of joints represented in the first image data has an expected joint position when the robot is in the first pose, at least one member of the set of members couples the first joint to the second joint, and the controller is further configured to determine that a second encoder of a second actuator associated with the second joint is properly calibrated when it is determined that the actual joint position of the first joint matches the expected joint position of the first joint.

In another aspect, the controller is configured to receive the first image data, determine the actual joint position, and configure the first encoder as part of a start-up operation of the robot.

In another aspect, configuring the first encoder based, at least in part, on the actual joint position of the first joint when it is determined that the actual joint position of the first joint is different from the expected joint position of the first joint comprises after configuring the first encoder, receiving second image data from the at least one sensor when the robot is in a second pose, wherein the first joint represented in the second image data has an expected joint position when the robot is in the second pose, determining, based on the second image data, an actual joint position of the first joint when the robot is in the second pose, and determining that the first encoder is properly calibrated when it is determined that the actual joint position of the first joint when the robot is in the second pose matches the expected joint position of the first joint when the robot is in the second pose.

In another aspect, robot further comprises the at least one sensor. In another aspect, the robot further comprises a vision system, wherein at least one sensor is included in the vision system. In another aspect, the robot further comprises a head, wherein the vision system is included in the head.

In another aspect, the at least one sensor includes a sensor located in an environment of the robot.

In another aspect, the controller is further configured to output an indication that the robot may be operated safely when it is determined that the actual joint position matches the expected joint position. In another aspect outputting an indication that the robot may be operated safely comprises controlling the robot to perform a first task.

In some embodiments, the invention features a controller. The controller is configured to receive first image data from at least one sensor when a robot is in a first pose, wherein a first joint of the robot is represented in the first image data has an expected joint position when the robot is in the first pose, determine, based on the first image data, an actual joint position of the first joint when the robot is in the first pose, and configure a first encoder of a first actuator associated with the first joint based, at least in part, on the actual joint position of the first joint when it is determined that the actual joint position of the first joint is different from the expected joint position of the first joint.

In one aspect, the controller is further configured to receive second image data from the at least one sensor when the robot is in a second pose, wherein a second joint of the robot represented in the second image data has an expected joint position when the robot is in the second pose, determine, based on the second image data, an actual joint position of the second joint when the robot is in the second pose, and configure a second encoder of a second actuator associated with the second joint based, at least in part, on the actual joint position of the second joint when it is determined that the actual joint position of the second joint is different from the expected joint position of the second joint.

In another aspect, configuring the first encoder based, at least in part, on the actual joint position of the first joint comprises configuring the first encoder to scale an output of the first encoder by a scaling factor, the scaling factor being determined based on a difference between the actual joint position and the expected joint position.

In another aspect, the first image data comprises three-dimensional (3D) image data and determining, based on the first image data, the actual joint position of the first joint when the robot is in the first pose comprises performing object detection to identify the first joint represented in the 3D image data, determining, using the 3D image data, a distance from the at least one sensor to the first joint, and determining the actual joint position of the first joint when the robot is in the first pose based on the distance from the at least one sensor to the first joint. In another aspect, performing object detection to identify the first joint represented in the 3D image data comprises identifying a visually-identifiable feature on the robot, wherein the visually-identifiable feature is represented in the 3D image data and identifies the first joint. In another aspect, the visually-identifiable feature comprises a fiducial mark. In another aspect, the fiducial mark comprises an infrared reflector, a bump or a line on the robot.

In another aspect, a second joint of the robot represented in the first image data has an expected joint position when the robot is in the first pose, and the controller is further configured to determine, based on the first image data, an actual joint position of the second joint when the robot is in the first pose, and configure a second encoder of a second actuator associated with the second joint based, at least in part, on the actual joint position of the second joint when it is determined that the actual joint position of the second joint is different from the expected joint position of the second joint. In another aspect, the first joint of the robot is coupled to a first member of the robot and the second joint of the robot is coupled to a second member of the robot, the second member not being coupled to the first joint of the robot.

In another aspect, the first joint of the robot is coupled to a first member of the robot and the second joint of the robot is coupled to the first member of the robot. In another aspect, the first member is a member of an arm or a leg of the robot.

In another aspect, determining, based on the first image data, the actual joint position of the first joint and the actual joint position of the second joint comprises determining, based on the first image data, that the first joint is aligned with the second joint when the first joint is in the expected joint position, and determining the actual joint position of the second joint in response to determining that the first joint is aligned with the second joint. In another aspect, determining that the first joint is aligned with the second joint comprises determining that the first joint and the second joint are aligned in a straight line.

In another aspect, determining, based on the first image data, that the first joint is aligned with the second joint when the first joint is in the expected joint position comprises identifying a first visually identifiable feature represented in the first image data, wherein the first visually identifiable feature identifies the first joint, identifying a second visually identifiable feature represented in the first image data, wherein the second visually identifiable feature identifies the second joint, determining that the first joint is aligned with the second joint when the first visually identifiable feature and the second visually identifiable feature have a particular spatial relationship. In another aspect, the particular spatial relationship comprises a straight line from the first joint to the second joint.

In another aspect, a second joint of the robot represented in the first image data has an expected joint position when the robot is in the first pose, at least one member of the robot couples the first joint to the second joint, and the controller is further configured to determine an actual joint position of the second joint using the actual joint position of the first joint.

In another aspect, a second joint of the robot represented in the first image data has an expected joint position when the robot is in the first pose, at least one member of the robot couples the first joint to the second joint, and the controller is further configured to determine that a second encoder of a second actuator associated with the second joint is properly calibrated when it is determined that the actual joint position of the first joint matches the expected joint position of the first joint.

In another aspect, the controller is configured to receive the first image data, determine the actual joint position, and configure the first encoder as part of a start-up operation of the robot.

In another aspect, configuring the first encoder based, at least in part, on the actual joint position of the first joint when it is determined that the actual joint position of the first joint is different from the expected joint position of the first joint comprises after configuring the first encoder, receiving second image data from the at least one sensor when the robot is in a second pose, wherein the first joint of the robot represented in the second image data has an expected joint position when the robot is in the second pose, determining, based on the second image data, an actual joint position of the first joint when the robot is in the second pose, and determining that the first encoder is properly calibrated when it is determined that the actual joint position of the first joint when the robot is in the second pose matches the expected joint position of the first joint when the robot is in the second pose.

In another aspect, the at least one sensor includes a sensor coupled to the robot. In another aspect, the at least one sensor is included in a vision system of the robot. In another aspect, wherein the vision system of the robot is included in a head of the robot.

In another aspect, the at least one sensor includes a sensor located in an environment of the robot.

In another aspect, the controller is further configured to output an indication that the robot may be operated safely when it is determined that the actual joint position matches the expected joint position. In another aspect, outputting an indication that the robot may be operated safely comprises controlling the robot to perform a first task.

### BRIEF DESCRIPTION OF DRAWINGS

The advantages of the invention, together with further advantages, may be better understood by referring to the following description taken in conjunction with the accompanying drawings. The drawings are not necessarily to scale, and emphasis is instead generally placed upon illustrating the principles of the invention.

FIG. 1 illustrates a configuration of a robotic system, according to an illustrative embodiment of the invention.

FIG. 2A shows an example of a humanoid robot, according to an illustrative embodiment of the invention.

FIG. 2B shows an example of various actuators of a humanoid robot, according to an illustrative embodiment of the invention.

FIG. 3 shows an example control architecture for a robot, according to an illustrative embodiment of the invention.

FIG. 4 is a flowchart of a process for configuring an actuator of a robot, according to an illustrative embodiment of the invention.

FIG. 5A depicts a first scenario including a robot configured to verify expected positions of robot members for a robot pose using a vision system, according to an illustrative embodiment of the invention.

FIG. 5B depicts a second scenario including a robot configured to verify expected positions of robot members for a robot pose using a vision system, according to an illustrative embodiment of the invention.

FIG. 6A depicts a mismatch between expected positions of robot members and actual positions of robot members, according to an illustrative embodiment of the invention.

FIG. 6B depicts alignment of expected position of robot members and actual positions of robot members, according to an illustrative embodiment of the invention.

### DETAILED DESCRIPTION

The following detailed description describes various features and operations of the disclosed systems with reference to the accompanying figures. The illustrative implementations described herein are not meant to be limiting. Certain aspects of the disclosed systems can be arranged and combined in a wide variety of different configurations, all of which are contemplated herein.

Safe operation of robots (e.g., humanoid robots) may require that the absolute position of the joints of the robots be known. Encoders associated with actuators in the joints of the robot may be used to determine a rotor position associated with the actuators. Knowledge about the rotor positions may be used to determine the absolute position of the joints. The inventors have recognized and appreciated that safe operation of robots using encoder readings may only be ensured if it can be determined that the encoders are properly calibrated, such that their readings can be relied upon to determine the absolute position of joints of the robot. Some embodiments of the present disclosure relate to using image data to perform a calibration of an encoder of an actuator. Such an approach provides parts count, complexity, and/or cost savings over conventional robot joint designs, which may require an extra output encoder to determine the absolute joint position.

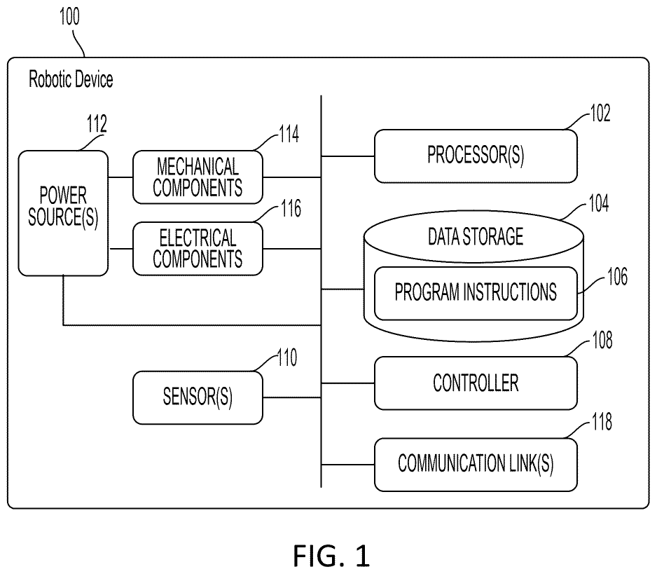

Referring now to the figures, FIG. 1 illustrates an example configuration of a robotic device (or “robot”) 100, according to an illustrative embodiment of the invention. The robotic device 100 represents an example robotic device configured to perform the operations described herein. Additionally, the robotic device 100 may be configured to operate autonomously, semi-autonomously, and/or using directions provided by user(s), and may exist in various forms, such as a humanoid robot, biped, quadruped, or other mobile robot, among other examples. Furthermore, the robotic device 100 may also be referred to as a robotic system, mobile robot, or robot, among other designations.

As shown in FIG. 1, the robotic device 100 includes processor(s) 102, data storage 104, program instructions 106, controller 108, sensor(s) 110, power source(s) 112, mechanical components 114, and electrical components 116. The robotic device 100 is shown for illustration purposes and may include more or fewer components without departing from the scope of the disclosure herein. The various components of robotic device 100 may be connected in any manner, including via electronic communication means, e.g., wired or wireless connections. Further, in some examples, components of the robotic device 100 may be positioned on multiple distinct physical entities rather on a single physical entity. Other example illustrations of robotic device 100 may exist as well.

Processor(s) 102 may operate as one or more general-purpose processor or special purpose processors (e.g., digital signal processors, application specific integrated circuits, etc.). The processor(s) 102 can be configured to execute computer-readable program instructions 106 that are stored in the data storage 104 and are executable to provide the operations of the robotic device 100 described herein. For instance, the program instructions 106 may be executable to provide operations of controller 108, where the controller 108 may be configured to cause activation and/or deactivation of the mechanical components 114 and the electrical components 116. The processor(s) 102 may operate and enable the robotic device 100 to perform various functions, including the functions described herein.

The data storage 104 may exist as various types of storage media, such as a memory. For example, the data storage 104 may include or take the form of one or more computer-readable storage media that can be read or accessed by processor(s) 102. The one or more computer-readable storage media can include volatile and/or non-volatile storage components, such as optical, magnetic, organic or other memory or disc storage, which can be integrated in whole or in part with processor(s) 102. In some implementations, the data storage 104 can be implemented using a single physical device (e.g., one optical, magnetic, organic or other memory or disc storage unit), while in other implementations, the data storage 104 can be implemented using two or more physical devices, which may communicate electronically (e.g., via wired or wireless communication). Further, in addition to the computer-readable program instructions 106, the data storage 104 may include additional data such as diagnostic data, among other possibilities.

The robotic device 100 may include at least one controller 108, which may interface with the robotic device 100. The controller 108 may serve as a link between portions of the robotic device 100, such as a link between mechanical components 114 and/or electrical components 116. In some instances, the controller 108 may serve as an interface between the robotic device 100 and another computing device. Furthermore, the controller 108 may serve as an interface between the robotic device 100 and a user(s). The controller 108 may include various components for communicating with the robotic device 100, including one or more joysticks or buttons, among other features. The controller 108 may perform other operations for the robotic device 100 as well. Other examples of controllers may exist as well.

Additionally, the robotic device 100 includes one or more sensor(s) 110 such as force sensors, proximity sensors, motion sensors, load sensors, position sensors, touch sensors, depth sensors, ultrasonic range sensors, and/or infrared sensors, among other possibilities. The sensor(s) 110 may provide sensor data to the processor(s) 102 to allow for appropriate interaction of the robotic device 100 with the environment as well as monitoring of operation of the systems of the robotic device 100. The sensor data may be used in evaluation of various factors for activation and deactivation of mechanical components 114 and electrical components 116 by controller 108 and/or a computing system of the robotic device 100.

The sensor(s) 110 may provide information indicative of the environment of the robotic device for the controller 108 and/or computing system to use to determine operations for the robotic device 100. For example, the sensor(s) 110 may capture data corresponding to the terrain of the environment or location of nearby objects, which may assist with environment recognition and navigation, etc. In an example configuration, the robotic device 100 may include a sensor system that may include a camera, RADAR, LIDAR, time-of-flight camera, global positioning system (GPS) transceiver, and/or other sensors for capturing information of the environment of the robotic device 100. The sensor(s) 110 may monitor the environment in real-time and detect obstacles, elements of the terrain, weather conditions, temperature, and/or other parameters of the environment for the robotic device 100.

Further, the robotic device 100 may include other sensor(s) 110 configured to receive information indicative of the state of the robotic device 100, including sensor(s) 110 that may monitor the state of the various components of the robotic device 100. The sensor(s) 110 may measure activity of systems of the robotic device 100 and receive information based on the operation of the various features of the robotic device 100, such the operation of extendable legs, arms, or other mechanical and/or electrical features of the robotic device 100. The sensor data provided by the sensors may enable the computing system of the robotic device 100 to determine errors in operation as well as monitor overall functioning of components of the robotic device 100.

For example, the computing system may use sensor data to determine the stability of the robotic device 100 during operations as well as measurements related to power levels, communication activities, components that require repair, among other information. As an example configuration, the robotic device 100 may include gyroscope(s), accelerometer(s), and/or other possible sensors to provide sensor data relating to the state of operation of the robotic device. Further, sensor(s) 110 may also monitor the current state of a function, such as a gait, that the robotic device 100 may currently be operating. Additionally, the sensor(s) 110 may measure a distance between a given robotic leg of a robotic device and a center of mass of the robotic device. Other example uses for the sensor(s) 110 may exist as well.

Additionally, the robotic device 100 may also include one or more power source(s) 112 configured to supply power to various components of the robotic device 100. Among possible power systems, the robotic device 100 may include a hydraulic system, electrical system, batteries, and/or other types of power systems. As an example illustration, the robotic device 100 may include one or more batteries configured to provide power to components via a wired and/or wireless connection. Within examples, components of the mechanical components 114 and electrical components 116 may each connect to a different power source or may be powered by the same power source. Components of the robotic device 100 may connect to multiple power sources as well.

Within example configurations, any type of power source may be used to power the robotic device 100, such as a gasoline and/or electric engine. Further, the power source(s) 112 may charge using various types of charging, such as wired connections to an outside power source, wireless charging, combustion, or other examples. Other configurations may also be possible. Additionally, the robotic device 100 may include a hydraulic system configured to provide power to the mechanical components 114 using fluid power. Components of the robotic device 100 may operate based on hydraulic fluid being transmitted throughout the hydraulic system to various hydraulic motors and hydraulic cylinders, for example. The hydraulic system of the robotic device 100 may transfer a large amount of power through small tubes, flexible hoses, or other links between components of the robotic device 100. Other power sources may be included within the robotic device 100.

Mechanical components 114 can represent hardware of the robotic device 100 that may enable the robotic device 100 to operate and perform physical functions. As a few examples, the robotic device 100 may include actuator(s), extendable leg(s) (“legs”), arm(s), wheel(s), one or multiple structured bodies for housing the computing system or other components, and/or other mechanical components. The mechanical components 114 may depend on the design of the robotic device 100 and may also be based on the functions and/or tasks the robotic device 100 may be configured to perform. As such, depending on the operation and functions of the robotic device 100, different mechanical components 114 may be available for the robotic device 100 to utilize. In some examples, the robotic device 100 may be configured to add and/or remove mechanical components 114, which may involve assistance from a user and/or other robotic device. For example, the robotic device 100 may be initially configured with four legs, but may be altered by a user or the robotic device 100 to remove two of the four legs to operate as a biped. Other examples of mechanical components 114 may be included.

The electrical components 116 may include various components capable of processing, transferring, providing electrical charge or electric signals, for example. Among possible examples, the electrical components 116 may include electrical wires, circuitry, and/or wireless communication transmitters and receivers to enable operations of the robotic device 100. The electrical components 116 may interwork with the mechanical components 114 to enable the robotic device 100 to perform various operations. The electrical components 116 may be configured to provide power from the power source(s) 112 to the various mechanical components 114, for example. Further, the robotic device 100 may include electric motors. Other examples of electrical components 116 may exist as well.

In some implementations, the robotic device 100 may also include communication link(s) 118 configured to send and/or receive information. The communication link(s) 118 may transmit data indicating the state of the various components of the robotic device 100. For example, information read in by sensor(s) 110 may be transmitted via the communication link(s) 118 to a separate device. Other diagnostic information indicating the integrity or health of the power source(s) 112, mechanical components 114, electrical components 116, processor(s) 102, data storage 104, and/or controller 108 may be transmitted via the communication link(s) 118 to an external communication device.

In some implementations, the robotic device 100 may receive information at the communication link(s) 118 that is processed by the processor(s) 102. The received information may indicate data that is accessible by the processor(s) 102 during execution of the program instructions 106, for example. Further, the received information may change aspects of the controller 108 that may affect the behavior of the mechanical components 114 or the electrical components 116. In some cases, the received information indicates a query requesting a particular piece of information (e.g., the operational state of one or more of the components of the robotic device 100), and the processor(s) 102 may subsequently transmit that particular piece of information back out the communication link(s) 118.

In some cases, the communication link(s) 118 include a wired connection. The robotic device 100 may include one or more ports to interface the communication link(s) 118 to an external device. The communication link(s) 118 may include, in addition to or alternatively to the wired connection, a wireless connection. Some example wireless connections may utilize a cellular connection, such as CDMA, EVDO, GSM/GPRS, or 4G telecommunication, such as WiMAX or LTE. Alternatively or in addition, the wireless connection may utilize a Wi-Fi connection to transmit data to a wireless local area network (WLAN). In some implementations, the wireless connection may also communicate over an infrared link, radio, Bluetooth, or a near-field communication (NFC) device.

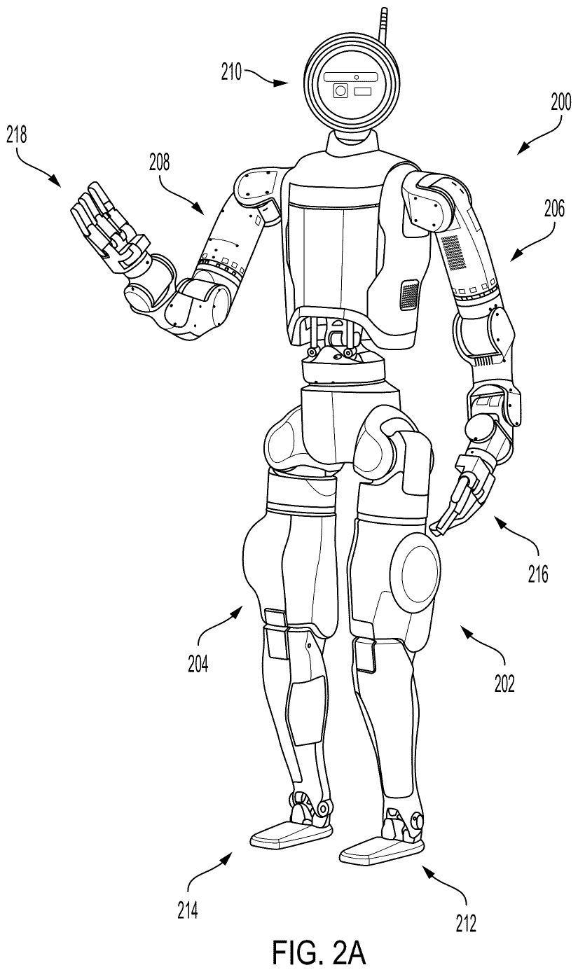

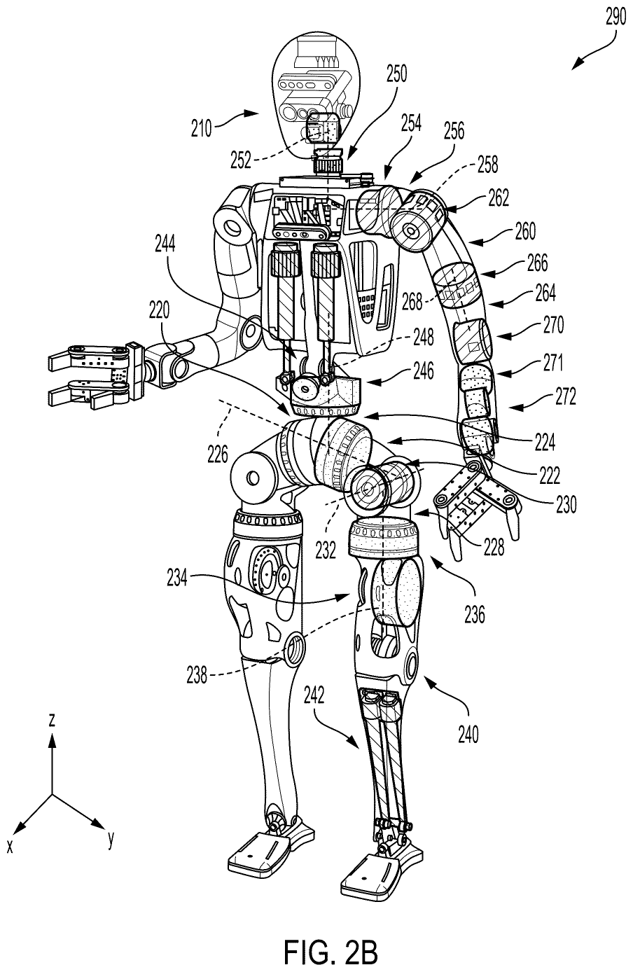

FIG. 2A illustrates an example of a humanoid robot, according to an illustrative embodiment of the invention. The robot 200 may correspond to the robotic device 100 shown in FIG. 1. The robot 200 serves as a possible implementation of a robotic device that may be configured to include the systems and/or carry out the methods described herein. Other example implementations of robotic devices may exist.

The robot 200 may include a number of articulated appendages, such as robotic legs 202, 204 and/or robotic arms 206, 208. The robot 200 may also include a robotic head 210, which may contain one or more vision sensors (e.g., cameras, infrared sensors, object sensors, range sensors, etc.). Each articulated appendage may include a number of (e.g., one, two, three or more) members connected by joints that allow the articulated appendage to move through certain degrees of freedom. For example, each robotic leg 202, 204 may include a respective foot 212, 214, which may contact a surface (e.g., a ground surface). The legs 202, 204 may enable the robot 200 to travel at various speeds according to various gaits. In addition, each robotic arm 206, 208 may facilitate object manipulation, load carrying, and/or balancing of the robot 200. Each arm 206, 208 may also include one or more members connected by joints and may be configured to operate with various degrees of freedom. Each arm 206, 208 may also include a respective end effector (e.g., gripper, hand, etc.) 216, 218. The robot 200 may use end effectors 216, 218 for interacting with (e.g., gripping, turning, pulling, and/or pushing) objects. Each end effector 216, 218 may include various types of appendages or attachments, such as fingers, attached tools or grasping mechanisms. In some embodiments, one or more sensors (e.g., cameras, infrared sensors, object sensors, range sensors, etc.) may be arranged on an arbitrary member or link of the robot.

Robot 200 may also include sensors to measure the angles of the joints of its articulated appendages. In addition, the articulated appendages may include a number of actuators that can be controlled to extend and retract members of the articulated appendages. Examples of actuators that may be included in robot 200 are described in more detail in FIG. 2B. In some cases, the angle of a joint may be determined based on the extent of protrusion or retraction of a given actuator. In some instances, the joint angles may be inferred from position data of inertial measurement units (IMUs) mounted on the members of an articulated appendage. In some implementations, the joint angles may be measured using rotary position sensors, such as rotary encoders. In other implementations, the joint angles may be measured using optical reflection techniques. Other joint angle measurement techniques may also be used.

In some embodiments, robot 200 may include a set of continuous rotation joints, where each continuous rotation joint permits continuous (e.g., 360 degree and/or limitless) rotation about a corresponding axis. Rather than requiring such joints to “unwind” by, for example, always determining a target joint angle relative to a nominal (e.g., 0 degree) orientation, a control system of the robot 200 may be configured to determine that the target joint angle be set at any multiple of 360 degrees (e.g., 0 degrees, 360 degrees, 620 degrees) to permit efficient movement of an attached member about the joint to achieve the target joint angle. For instance, if a target joint angle of a continuous rotation joint is 15 degrees and the current joint angle is 350 degrees, rather that rotating an attached member −335 degrees about the joint, the attached member can instead be rotated +25 degrees (to 375 degrees), which is equivalent to a joint angle of 15 degrees for a continuous rotation joint.

In some embodiments, robot 200 may include a body (e.g., a torso and a base such as a pelvis base) and one or more kinematic chains of robot members (e.g., arms, legs) coupled to the body. Each of the plurality of kinematic chains of robot members may include at least two joints (e.g., a first joint coupling the kinematic chain to the body and a second joint coupling at least two members of the kinematic chain). At least one of the at least two joints in a kinematic chain may be a continuous rotation joint that enables continuous rotation of at least one of the members (and possibly all members if the joint that couples the kinematic member to the body is a continuous rotation joint) of the kinematic chain about the joint.

Robot 200 may be configured to send sensor data from the articulated appendages to a device coupled to robot 200 such as a processing system, a computing system, or a control system. Robot 200 may include a memory, either included in a device on robot 200 or as a standalone component, on which sensor data is stored. In some implementations, the sensor data is retained in the memory for a certain amount of time. In some cases, the stored sensor data may be processed or otherwise transformed for use by a control system on robot 200. In some cases, robot 200 may also transmit the sensor data over a wired or wireless connection (or other electronic communication means) to an external device.

FIG. 2B illustrates an example of a humanoid robot 290, according to an illustrative embodiment of the invention. Humanoid robot 290 may include components (e.g., arms, legs, feet, head) similar to robot 200 of FIG. 2A, which may not be relabeled in FIG. 2B to reduce clutter. Overlaid on the depiction of humanoid robot 290 are a set of actuators that may be used to move an attached member at corresponding joints of the humanoid robot 290 to enable movement of the robot. As described in more detail below, humanoid robot 290 may include different types of actuators and joints that enable different members of the robot to move with varying degrees of freedom, permitting flexibility of movement when desired while restricting movement as appropriate to, for example, avoid or reduce the risk of collisions between robot components.

Humanoid robot 290 includes a base member (e.g., a pelvis base, as shown in FIG. 2B) 220. The pelvis base 220 is rotatably connected to a first hip member 222. An electric actuator 224 may be disposed between the pelvis base 220 and the first hip member 222 (e.g., in, between, connected to, and/or as part of one or both components). In some embodiments, a first portion of the electric actuator 224 may be fixed to the pelvis base 220, and a second portion of the electric actuator 224 may be fixed to the first hip member 222. The electric actuator 224 may be configured to rotate the pelvis base 220 relative to the first hip member 222 about an axis (e.g., a first hip-y axis) 226. The first hip member 222 is also connected to a first intermediate leg member 228. An electric actuator 230 may be disposed between the first hip member 222 and the first intermediate leg member 228 (e.g., in, between, connected to, and/or as part of one or both components). In some embodiments, a first portion of the electric actuator 230 may be fixed to the first hip member 222, and a second portion of the electric actuator 230 may be fixed to the first intermediate leg member 228. The electric actuator 230 may be configured to rotate the first hip member 222 relative to the first intermediate leg member 228 about an axis (e.g., a first hip-x axis) 232. The first intermediate leg member 228 is also connected to a first leg member 234. An electric actuator 236 may be disposed between the first intermediate member 228 and the first leg member 234 (e.g., in, between, connected to, and/or as part of one or both components). In some embodiments, a first portion of the electric actuator 236 may be fixed to the first intermediate member 228, and a second portion of the electric actuator 236 may be fixed to the first leg member 234. The electric actuator 236 may be configured to rotate the first intermediate leg member 228 relative to the first leg member 234 about an axis (e.g., a first hip-z axis) 238. In some embodiments, a second hip member, second intermediate leg member, and second leg member are connected in similar fashion to the first hip member, first intermediate leg member, and first leg member, using similar actuators rotating along similar additional axes and/or providing similar independently actuatable degrees of freedom.

The axis 226 may be referred to as a first hip-y axis, which denotes a flexion/extension axis of the robot 200. The axis 232 may be referred to as a first hip-x axis, which denotes an abduction/adduction axis. The axis 238 may be referred to as a first hip-z axis, which denotes a pronation/supination axis. FIG. 2B shows a set of reference axes to illustrate the x, y and z directions, although the actual x, y, and z axes in the robot 200 need not be mutually orthogonal or extend from the same origin. In some embodiments, rotation about the first hip-y axis 226 may cause the robot leg 202 to swing upward and backward (e.g., in a direction that would enable the robot 200 to walk forward and backward). In some embodiments, rotation about the first hip-x axis 232 may cause the robot leg 202 to swing inward (e.g., toward a center line between the legs 202, 204 of the robot 200) and outward. In some embodiments, rotation about the first hip-z axis may cause the robot leg 202 to rotate the stance of the leg (e.g., twist it to the left or to the right). In some embodiments, the leg member 234 is an upper leg member, which may in turn be connected to a lower leg member 242 at a knee joint 240. In some embodiments, the lower leg member 242 is connected to a foot (e.g., foot 212) at an ankle joint.

In some embodiments, the pelvis base 220 is rotatably connected and/or configured to be rotatably connected to a back member 244 (also referred to herein as a “torso”) of the robot 290. An electric actuator 246 may be disposed between the pelvis base 220 and the back member 244 (e.g., in, between, connected to, and/or part of one or both components). In some embodiments, a first portion of the electric actuator 246 may be fixed to the pelvis base 220, and a second portion of the electric actuator 246 may be fixed to the back member 244. The electric actuator 246 may be configured to rotate the back member 244 relative to pelvis base 220 about an axis (e.g., back-z axis) 248. In some embodiments, the back member 244 is rotatably connected and/or configured to be rotatably connected to a head 210 of the robot 290. An electric actuator 250 may be disposed between the back member 244 and the head 210 (e.g., in, between, connected to, and/or part of one or both components). In some embodiments, a first portion of the electric actuator 250 may be fixed to the head 210 and a second portion of the electric actuator 250 may be fixed to the back member 244. The electric actuator 250 may be configured to rotate the head 210 relative to the back member 244 about an axis (e.g., neck-z axis) 252.

In some embodiments, a first shoulder member 256 is rotatably connected and/or configured to be rotatably connected to a back member 244 of the robot 290. An electric actuator 254 may be disposed between the back member 244 and the first shoulder member 256 (e.g., in, between, connected to, and/or part of one or both components). In some embodiments, a first portion of the electric actuator 254 may be fixed to the first shoulder member 256, and a second portion of the electric actuator 254 may be fixed to the back member 244. The electric actuator 254 may be configured to rotate the first shoulder member 256 relative to the back member 244 about an axis (e.g., shoulder-y axis) 258. In some embodiments, the first shoulder member 256 is rotatably connected and/or configured to be rotatably connected to a first intermediate arm member 260 of the robot 290. An electric actuator 262 may be disposed between the first shoulder member 256 and the first intermediate arm member 260 (e.g., in, between, connected to, and/or part of one or both components). In some embodiments, a first portion of the electric actuator 262 may be fixed to the first intermediate arm member 260, and a second portion of the electric actuator 262 may be fixed to the first shoulder member 256. The electric actuator 262 may be configured to rotate the first intermediate arm member 260 relative to the first shoulder member 256 about an axis to provide adduction/abduction of the first intermediate arm member 260 relative to the first shoulder member 256. In some embodiments, a first upper arm member 264 is rotatably connected and/or configured to be rotatably connected to the first intermediate arm member 260 of the robot 290. An electric actuator 266 may be disposed between the first arm member 264 and the first intermediate arm member 260 (e.g., in, between, connected to, and/or part of one or both components). In some embodiments, a first portion of the electric actuator 266 may be fixed to the first arm member 264, and a second portion of the electric actuator 266 may be fixed to the first intermediate arm member 260. The electric actuator 266 may be configured to rotate the first arm member 264 relative to the first intermediate arm member 260 about an axis (e.g., shoulder-z axis) 268.

In some embodiments, the first arm member 264 may in turn be connected to a first lower arm member 272 at a first elbow joint. An electric actuator 270 may be disposed between the first arm member 264 and the first lower arm member 272 (e.g., in, between, connected to, and/or part of one or both components). In some embodiments, a first portion of the electric actuator 270 may be fixed to the first arm member 264, and a second portion of the electric actuator 270 may be fixed to the first lower arm member 272. The electric actuator 270 may be configured to rotate the first arm member 264 relative to the first lower arm member 272 about an axis that provides flexion/extension of the first lower arm member 272 relative to the first arm member 264. In some embodiments, rotation about the first elbow joint may be greater than 90 degrees. In some embodiments, rotation about the first elbow joint may be greater than 180 degrees.

In some embodiments, the first lower arm member 272 is connected to an end effector (e.g., a gripper or hand) via a wrist component. The wrist component may contain one or more actuators configured to provide various ranges of motion to the wrist of the robot. In some embodiments, a second shoulder member, second intermediate arm member, second upper arm member, and second lower arm member are connected in similar fashion to the first shoulder member, first intermediate arm member, first upper arm member, and first lower arm member using similar actuators rotating along similar additional axes and/or providing similar independently actuatable degrees of freedom.

As described above, encoders, when properly calibrated, may be used to reliably determine the position of a rotor in an actuator located in a joint of a robot, and by extension, the rotor position may be used to determine an absolute position of the joint. Some typical actuator designs include two output encoders that provide redundancy and reliability for verifying encoder readings (e.g., upon robot startup). However, inclusion of redundant parts in a robot, such as multiple output encoders for each actuator, adds to the cost and complexity of the robot, and may not be needed if safe operation of the robot's actuators can be ensured using other techniques. The inventors have recognized and appreciated that the vision system of a robot, which is typically used to enable the robot to navigate and/or interact with objects in its environment may be used to confirm, validate, or otherwise configure encoders associated with actuators in joints of a robot to provide for safe operation of the robot.

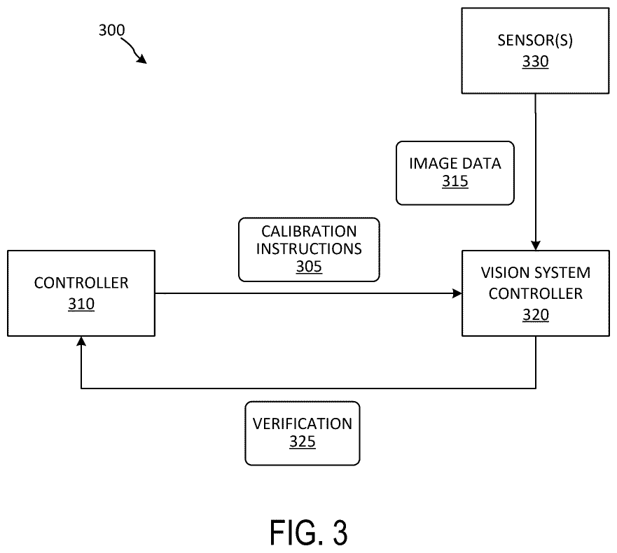

FIG. 3 illustrates an example control architecture 300 that may be used to calibrate an encoder of a robot actuator using image data, in accordance with some embodiments of the present disclosure. Control architecture 300 may include controller 310 (e.g., one or more hardware computer processors) configured to monitor and/or control operations of the robot, such as the movement of joints of the robot. In some embodiments, controller 310 may be further configured to instruct a vision system controller 320 (e.g., one or more hardware computer processors) to capture image data 315 using sensor(s) 330 in accordance with calibration instructions 305 provided from controller 310. For example, the sensor(s) 330 may include one or more cameras configured to capture one or more images of a portion of the robot (e.g., one or more members in a robot limb) and/or objects in the environment of the robot within the field of view of the sensor(s) 330. In some embodiments, sensor(s) 330 may be included as a portion of a vision system of the robot and may be used, for example, to enable the robot to navigate and/or interact with objects in the environment of the robot. For example, sensor(s) 330 may be coupled to a head of the robot, a chest of the robot, an arm of the robot, etc. In some embodiments, sensor(s) 330 may include one or more off-robot sensors, such as one or more sensors coupled to infrastructure (e.g., a wall, a ceiling, a floor, a post/pole, a shelf) in the environment of the robot and/or one or more sensors coupled to another robot. In some embodiments, the image data captured by sensor(s) 330 may include 3D image data. As described herein, the 3D image data may be used to determine a distance from the sensor(s) 330 to one or more joints (or members connected by joints) represented in the image data. In some embodiments, sensor(s) 330 may include a 2D camera (e.g., an RGB camera), a depth sensor, such as LiDAR sensor, a 3D camera, or any combination thereof such that sensor(s) 330 are configured to capture 3D image data, which may be used to make distance determinations. Vision system controller 320 may be configured to use image data 315 received from sensor(s) 350 to determine whether the actual position of a joint represented in the image data 315 differs from an expected position of the joint when the robot is in a particular pose.

Although shown as a separate component, it should be appreciated that, in some embodiments, one or more (e.g., all) functions of vision system controller 320 may be performed by controller 310. As should be appreciated, in such embodiments, it may not be necessary to send calibration instructions 305 from controller 310 to another component. Rather, controller 310 may be configured to determine when to initiate a calibration operation using one or more the techniques described herein. For example, the controller 310 may be configured to initiate a calibration operation to calibrate an encoder of an actuator, and may initiate such a calibration operation by controlling (directly or indirectly) sensor(s) 330 to capture and process image data 315. In some embodiments, the calibration operation may be performed during a startup sequence of a robot (e.g., during robot power up) or at any other suitable time (e.g., once a day, once a week, after a robot fall or collision, etc.).

Upon robot startup, the controller 310 may initiate a calibration operation to calibrate the encoders of the joints of the robot to ensure safe operation of the robot. As described herein, calibration of the encoders may include controlling the robot to move its joints such that the robot may assume one or more poses in which the vision system controller 320 can determine that an actual positions of the joints of the robot match the expected position of the joints of the robot when the robot assumes the pose(s). If the vision system controller 320 determines that the actual position of one or more of the joints is different than the expected position of the joint(s), the vision system controller 320 may send verification data 325 to controller 310, where the verification data indicates that the actual position of the joint is different than the expected position of the joint. In response to receiving such verification data 325, the controller 310 may configure the input encoder of the actuator according to the actual position of the joint. If the vision system controller 320 determines that the actual position of the joint(s) matches the expected position of the joint(s) when the robot is in the particular pose, the vision system controller 320 may send verification data 325 to the controller 310 indicating that the input encoder of the actuator is properly configured. The calibration operation may be performed for one or more (e.g., all) joints of the robot by controlling the robot to execute different poses that place various joints within the field of view of the sensor(s) 330 until it is determined that the input encoders of the respective actuators are properly calibrated and the robot may operate safely. For example, upon determining calibration is necessary or desired, the robot may be configured to execute a series of poses during which calibration of the set of joints of the robot is performed. In some embodiments, the series of poses may be performed as a “stretching routine” or other sequence of natural movements upon robot power up.

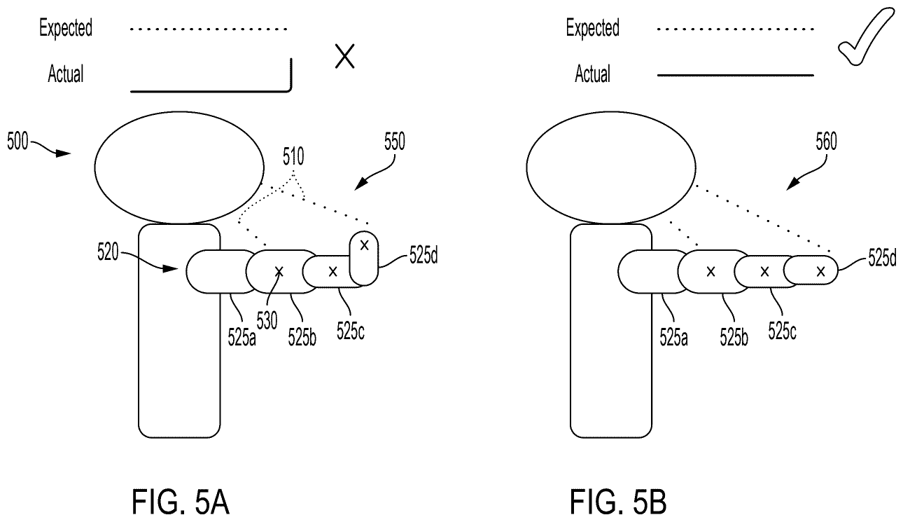

As described herein, in some embodiments, a calibration operation may include controlling the robot to move into a particular pose, such that when the robot is in the particular pose, one or more joints of the robot are within a field of view of the sensor(s) with each of the one or more joints having an expected position. At least some of the poses assumed by the robot during the calibration operation may align one or more joints into a position where the expected position of the joints has only a singular solution. For example, performing the calibration operation may include moving the robot to a pose (e.g., from a starting pose of the robot, such as a neutral standing position with the arms of the robot parallel to a torso of the robot), which may include extending an arm of the robot straight out in front of the robot, as illustrated in FIGS. 5A and 5B. Moving the robot into the pose may include moving one or more joints into expected positions for the pose, such as moving a shoulder joint into a first expected position, an elbow joint into a second expected position, and a wrist joint into a third expected position. Once the pose has been assumed by the robot, the input encoders for each of the joints may be calibrated using the techniques described herein.

By understanding the morphology of the robot and a position of the sensor(s) 330 in space, an expected position of a joint relative to the position of the sensor(s) 330 when the robot is in a particular pose may be determined. In some embodiments, the sensor(s) 330 may be included as a portion of a vision system located in the head of the robot. An initial calibration of one or more neck actuators in the robot may be performed by positioning the head of the robot such that the sensor(s) 330 in the vision system of the robot can observe the position of one or more visually identifiable markings on the body or torso of the robot. Following this initial calibration after which the position of the sensor(s) 330 relative to the torso may be determined, calibration of one or more joints in the appendages (e.g., arms, legs, etc.) of the robot may be performed using one or more poses, as described herein.

In some embodiments, rather than having a separate calibration routine with a set of calibration poses, the actual position of one or more joints may be determined using the techniques described herein based on one or more robot poses included as a part of the task to be performed by the robot during normal operation. For example, execution of the task may require the robot to reach their arm straight out to reach for an object to be grasped by an end effector of the robot. In such embodiments, a calibration operation in accordance with the techniques described herein may be performed during performance of the task when the pose of the robot is such that the arms are fully extended and the joints of the arms are within a field of view of the sensor(s) 330.

In some embodiments, the calibration operation may be performed in a particular order of joints of the robot. For example, as described above, a first joint having an actuator to be calibrated may be a joint of an appendage that includes sensor(s) 330, such as a head of the robot, a torso of the robot, and/or an arm of the robot. After performing the calibration operation for the appendage including the sensor(s) 330, the calibration operation may be performed with respect to the remaining joints of the robot.

In some embodiments, the image data 315 may be used to verify that more than one joint captured in the image data is in an expected position such that the position of multiple joints can be determined from a single image. In some embodiments, the multiple joints whose position is determined from a single image may be associated with different appendages of the robot. For example, the image data captured when the robot is in a particular pose may include a representation of at least one joint of a first appendage of the robot (e.g., an arm) and a representation of at least one joint of a second appendage of the robot (e.g., another arm, a leg, etc.). The image data may be processed as described herein to verify that the actual position of the at least one joint of the first appendage and the actual position of the at least one joint of the second appendage are in their expected positions for the particular pose.

In some embodiments, a configuration operation for a joint may be performed by determining whether the actual position of one or more other joints identified in the image data 315 are in their expected position. For example, the vision system controller 320 may be configured to determine that a first joint is in an expected joint position based on determining the actual joint position of the first joint aligns with the actual joint position of a second joint of the robot and that the actual joint position of the second joint is in its expected position when the robot is in a particular pose. The vision system controller 320 may be configured to determine whether the first joint aligns with the second joint based on the first and second joints, or particular portions of the first and second joints (e.g., visually identifiable features associated with the first and second joints), aligning in a particular manner. For instance, for a pose of the robot in which the robot extends its arm in front of the robot in a straight line, the vision system controller 320 may be configured to determine whether the joints, or visually identifiable features associated with the joints, are aligned in a straight line. Based on determining the joints, or visually identifiable features associated with the joints, are aligned in the straight line, the vision system controller 320 may determine that the first joint is in the expected joint position for the pose.

In some embodiments, the vision system controller 320 may be configured to verify a position of a first joint (e.g., an upstream joint) based on verification of a second joint (e.g., a downstream joint). For example, a first joint (e.g., a shoulder, elbow, hip, or knee joint) may be upstream from a second joint (e.g., an elbow, a wrist, a knee, or an ankle joint, respectively) of an appendage of the robot (e.g., an arm, a leg, etc.). The first joint may be upstream from the second joint based on the second joint being coupled to the first joint via at least one member, such as when the second joint is coupled to a distal end of the at least one member and the first joint is coupled to a proximal end of the at least one member.

In some embodiments, the vision system controller 320 may be configured to verify the position of an upstream joint based on verification of a downstream joint when in particular poses of the robot, such as those that may require that all upstream joints be in expected joint positions for a downstream joint to be in an expected joint position. An example of such a pose of the robot may include a pose where an appendage of the robot is extended straight, such as straight out in front of the robot. In some embodiments, whether a pose of the robot may be used to verify the position of an upstream joint based on verification of a downstream joint may be indicated in the calibration instructions 305.

The vision system controller 320 may be configured to process image data to determine whether the second, downstream joint is in an expected joint position. For instance, a distance the downstream joint may be determined based on the image data and an actual position of the downstream joint may be determined based on the distance. The vision system controller 320 may be configured to determine that the encoder associated with the actuator in the downstream joint is correctly configured when the actual position of the downstream joint matches the expected position of the downstream joint. After verifying that the actuator in the downstream joint is correctly configured, the vision system controller 320 may be further configured to verify that the encoder associated with the actuator in the upstream joint is also correctly configured based on its linkage to the downstream joint in the robot configuration.

As discussed herein, if one or more joints of the robot are verified to be in corresponding expected joint positions, as determined by the vision system controller 320 using the calibration instructions 305 and image data 315, the controller 310 may be configured to continue operation of an assigned task, or otherwise continue normal operation of the robot. On the other hand, if the actual joint positions of one or more joints of the robot are determined to be different than their corresponding expected joint positions, the input encoder(s) of the one or more joints may be calibrated as described herein.

In some embodiments, the vision system controller 320 may be configured to confirm that the input encoder has been configured properly after a configuration operation has been performed. For example, after configuring an input encoder using the techniques described herein, the controller 310 may be configured to control the robot to move into a pose in which the joint can be visualized by the sensor(s) 330, and another calibration operation to verify that the actual position of the joint matches an expected position of the joint in the pose may be performed.

In some embodiments, when it is determined that the actual position of a joint does not match an expected position of a joint, an input encoder associated with an actuator in the joint may be calibrated based, at least in part, on the actual joint position of the joint. For example, in response to receiving verification data 325 indicating the actual joint position of a joint is different than an expected joint position, the controller 310 may be configured to determine a scaling factor based on a difference between the actual joint position of the joint and the expected joint position of the joint. The scaling factor may be used as a ratio or a multiplier to transform encoder readings into accurate encoder readings for safe operation of the robot. For example, the scaling factor may be applied to the output received from the encoder to determine an accurate rotor position of the actuator.

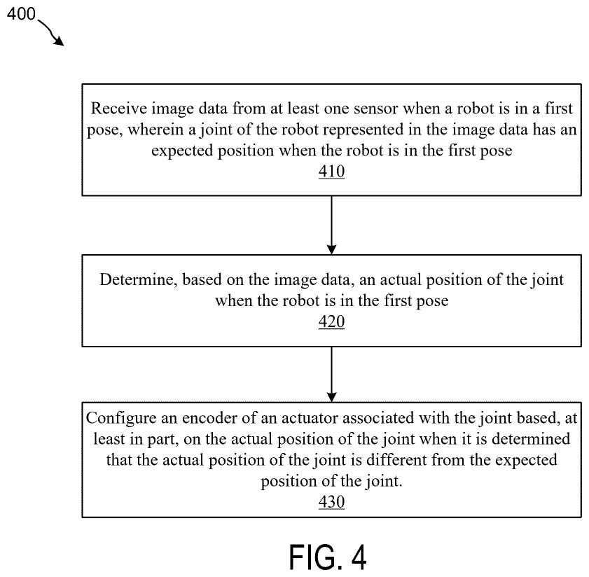

FIG. 4 is a flowchart of a process 400 for calibrating an encoder (e.g., an input encoder) of an actuator associated with a joint of a robot, in accordance with some embodiments. The actuator may be associated with input encoder used to determine a rotor position of the actuator. The input encoder may specify a current or starting position of the rotor of the actuator. A controller of the robot may control rotation of the rotor by rotating the rotor by an angle of rotation based on a reading of the input encoder and a desired joint position. As should be appreciated, to ensure that the actuator is safely and accurately controlled to move the joint to the desired joint position, the input encoder should be properly calibrated to have an accurate rotor position reading.

Process 400 may begin in act 410, where image data is received from at least one sensor (e.g., sensor(s) 330 when a robot is in a first pose, where a joint of the robot represented in the image data has an expected joint position when the robot is in the first pose. For example, as illustrated in and described herein in connection with FIGS. 3-6B, a vision system of the robot may include one or more sensors (e.g., one or more cameras) configured to capture image data (e.g., 3D distance-based image data, 2D image data, etc.) of a portion (e.g., an arm, a leg) of the robot that includes one or more joints. The image data may be captured after the robot has assumed a particular pose for which the one or more joints have an expected position. As an example, the arm of the robot, which includes multiple joints may be extended in a straight line such that all members of the arm and its corresponding joints are aligned from the shoulder joint to a joint that couples an end effector to the arm. In such a configuration, the positions of all of the joints in the arm may have a known single solution. It should be appreciated however, that performing a calibration operation using only poses that have a singular solution (e.g., straight line orientation of joints) may not be required as long as the position of all joints to be calibrated when the robot is in the pose is known. For instance, a pose used for calibration may have the members coupled to a joint oriented at a 90° orientation relative to each other.

Process 400 may then proceed to act 420, where an actual position of the joint when the robot is in the first pose may be determined based on the image data. For example, in some embodiments, when the at least one sensor used to capture the image data has a known spatial relationship relative to the joint, distance information determined based on the image data may be used to determine the actual position of the joint when the robot is in the particular pose. The distance information may be determined in any suitable way. For example, a visually identifiable feature (e.g., a fiducial marker) located on the robot may be used to determine the distance information.

Process 400 may then proceed to act 430, where an encoder of an actuator associated with the joint may be configured based, at least in part, on the actual position of the joint when it is determined that the actual position of the joint is different from the expected position of the first joint. For example, the input encoder associated with the actuator may be configured based on the actual joint position such that a reading of the input encoder when the joint is in the first pose accurately represents the rotor position of the actuator. As another example, the input encoder associated with the actuator may be configured to scale an output of the encoder by a scaling factor determined based on a difference between the actual joint position and the excepted joint position.

FIGS. 5A and 5B depict a robot 500 including a robotic arm 520 and a vision system 510. The robotic arm 520 may include a set of members 525a-d coupled by joints. The robot 500 may be configured to move the set of members 525a-d at their respective joints to perform various tasks using the robotic arm 520, such as moving the robotic arm 520 to grasp and/or carry an object. The vision system 510 may include one or more sensors configured to capture image data, which may be used to calibrate encoders associated with the actuators within each of the joints coupling segments 525a-d. In the pose 550 or the pose 560 illustrated in FIGS. 5A and 5B, the robot may be controlled to extend all of segments 525a-d of its robotic arm 520 in a straight line in front of the body of the robot such that the expected joint position of each of the segments aligns in a straight line.

When the robot 500 is in the pose 550 or the pose 560, the vision system 510 may capture image data of the robotic arm 520 of the robot 500. For example, as described herein, at least one sensor included in vision system 510 may capture image data, which may be processed to determine an actual position of one or more of the members 525a-d in the robotic arm 520. By extension, the position of the joint(s) in the robotic arm 520 may be determined. For example, the image data may be processed to determine a distance from the at least one sensor to one or more of the members 525a-d as shown. Based on the determination of the distance(s) to the one or more members, an actual joint position of the joints coupling the members 525a-d may be determined.

As illustrated in FIGS. 5A and 5B, a first distance from the sensor(s) in the vision system 510 to the second member 525b and a second distance from the sensor(s) in the vision system 510 to the fourth member 525d are determined when the robot 500 is in pose 550 or pose 560. In the scenario depicted in FIG. 5A, based on the first distance, it may be determined that the actual position of the second member 525b matches the expected position of the second member when in pose 550. However, based on the second distance, it may be determined that the actual position of the fourth member 525d does not match the expected position of the fourth member when in pose 550 (e.g., due to the second distance being shorter than the expected distance from the sensor(s) to the fourth member). In response to detecting the mismatch between actual and expected positions, an encoder associated with an actuator of the joint between the third member 525c and the fourth member 525d may be calibrated to correct the discrepancy. In the scenario depicted in FIG. 5B, it may be determined that both the second member 525b and the fourth member 525d match their expected positions when the robot 500 is in pose 560. Accordingly, it may be determined that the encoders of the joints connecting the segments are configured properly, and as such it may be determined that the robot may be safe to operate to perform tasks. As shown in FIGS. 5A and 5B, one or more visually identifiable features (e.g., fiducial marking 530) may be present on one or more of segments 525a-d to aid in the detection of those segments in the image data and/or to determine actual distances from the sensor(s) to an associated robot member.

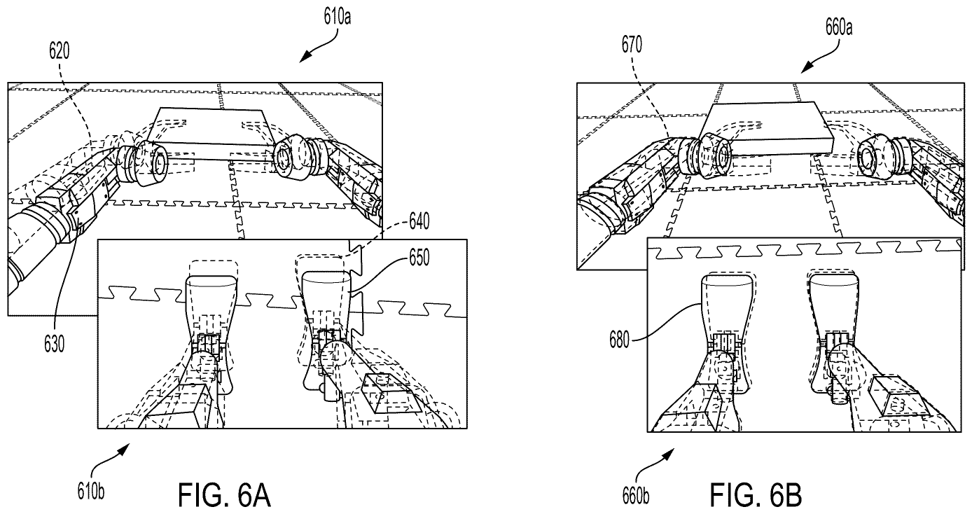

FIGS. 6A and 6B depict representations of an expected position of a portion of a robot and an actual position of the portion of the robot. FIG. 6A includes a first set of images 610a-b depicting scenarios where the actual positions of portions of the robot (arms and gripper in 610a; feet in 610b) do not match the expected positions for the portions of the robot, which are shown in outlined form.

As shown in the first set of images 610a-b, the actual position 630 of an arm of the robot and the actual position 650 of the foot of the robot do not match the expected position 620 of the arm (i.e., where the robot thinks the arm is in space) and the expected position 640 of the foot (i.e., where the robot thinks the foot is in space). Based on determining the actual positions 630, 650 of the members do not match the expected positions 620, 640 of the members, the expected positions of the members may be aligned to the actual positions as observed by the vision system of the robot. FIG. 6B shows a second set of images 660a-b, in which the actual positions of the members have been aligned with the expected positions 670, 680 of members.

A number of implementations have been described. Nevertheless, it will be understood that various modifications may be made without departing from the spirit and scope of the disclosure.

1. A method comprising:
receiving first image data from at least one sensor when a robot is in a first pose, wherein a first joint of the robot represented in the first image data has an expected joint position when the robot is in the first pose;
determining, based on the first image data, an actual joint position of the first joint when the robot is in the first pose; and
configuring a first encoder of a first actuator associated with the first joint based, at least in part, on the actual joint position of the first joint when it is determined that the actual joint position of the first joint is different from the expected joint position of the first joint.

2. The method of claim 1, further comprising:
receiving second image data from the at least one sensor when the robot is in a second pose, wherein a second joint of the robot represented in the second image data has an expected joint position when the robot is in the second pose;
determining, based on the second image data, an actual joint position of the second joint when the robot is in the second pose; and
configuring a second encoder of a second actuator associated with the second joint based, at least in part, on the actual joint position of the second joint when it is determined that the actual joint position of the second joint is different from the expected joint position of the second joint.

3. The method of claim 1, wherein configuring the first encoder based, at least in part, on the actual joint position of the first joint comprises:
configuring the first encoder to scale an output of the first encoder by a scaling factor, the scaling factor being determined based on a difference between the actual joint position and the expected joint position.

4. The method of claim 1, wherein the first image data comprises three-dimensional (3D) image data and determining, based on the first image data, the actual joint position of the first joint when the robot is in the first pose comprises:
performing object detection to identify the first joint represented in the 3D image data;
determining, using the 3D image data, a distance from the at least one sensor to the first joint; and
determining the actual joint position of the first joint when the robot is in the first pose based on the distance from the at least one sensor to the first joint.

5. The method of claim 4, wherein performing object detection to identify the first joint represented in the 3D image data comprises:
identifying a visually-identifiable feature on the robot, wherein the visually-identifiable feature is represented in the 3D image data and identifies the first joint.

6-7. (canceled)

8. The method of claim 1, wherein a second joint of the robot represented in the first image data has an expected joint position when the robot is in the first pose, and the method further comprises:
determining, based on the first image data, an actual joint position of the second joint when the robot is in the first pose; and
configuring a second encoder of a second actuator associated with the second joint based, at least in part, on the actual joint position of the second joint when it is determined that the actual joint position of the second joint is different from the expected joint position of the second joint.

9. The method of claim 8, wherein the first joint of the robot is coupled to a first member of the robot and the second joint of the robot is coupled to the first member of the robot.

10-11. (canceled)

12. The method of claim 8, wherein determining, based on the first image data, the actual joint position of the first joint and the actual joint position of the second joint comprises:
determining, based on the first image data, that the first joint is aligned with the second joint when the first joint is in the expected joint position; and
determining the actual joint position of the second joint in response to determining that the first joint is aligned with the second joint.

13. The method of claim 12, wherein determining that the first joint is aligned with the second joint comprises determining that the first joint and the second joint are aligned in a straight line.

14. The method of claim 12, wherein determining, based on the first image data, that the first joint is aligned with the second joint when the first joint is in the expected joint position comprises:
identifying a first visually identifiable feature represented in the first image data, wherein the first visually identifiable feature identifies the first joint;
identifying a second visually identifiable feature represented in the first image data, wherein the second visually identifiable feature identifies the second joint; and
determining that the first joint is aligned with the second joint when the first visually identifiable feature and the second visually identifiable feature have a particular spatial relationship.

15. (canceled)

16. The method of claim 1, wherein:
a second joint of the robot represented in the first image data has an expected joint position when the robot is in the first pose,
at least one member of the robot couples the first joint to the second joint, and
the method further comprises:
determining an actual joint position of the second joint using the actual joint position of the first joint.

17. The method of claim 1, wherein:
a second joint of the robot represented in the first image data has an expected joint position when the robot is in the first pose,
at least one member of the robot couples the first joint to the second joint, and
the method further comprises:
determining that a second encoder of a second actuator associated with the second joint is properly calibrated when it is determined that the actual joint position of the first joint matches the expected joint position of the first joint.

18. The method of claim 1, wherein the method is performed as part of a start-up operation of the robot.

19. The method of claim 1, wherein configuring the first encoder based, at least in part, on the actual joint position of the first joint when it is determined that the actual joint position of the first joint is different from the expected joint position of the first joint comprises:
after configuring the first encoder, receiving second image data from the at least one sensor when the robot is in a second pose, wherein the first joint of the robot represented in the second image data has an expected joint position when the robot is in the second pose;
determining, based on the second image data, an actual joint position of the first joint when the robot is in the second pose; and
determining that the first encoder is properly calibrated when it is determined that the actual joint position of the first joint when the robot is in the second pose matches the expected joint position of the first joint when the robot is in the second pose.

20. The method of claim 1, wherein the at least one sensor includes a sensor coupled to the robot.

21. The method of claim 20, wherein the at least one sensor is included in a vision system of the robot.

22-23. (canceled)

24. The method of claim 1, further comprising:
outputting an indication that the robot may be operated safely when it is determined that the actual joint position matches the expected joint position.

25. The method of claim 24, wherein outputting the indication that the robot may be operated safely comprises:
controlling the robot to perform a first task.

26. A robot comprising:
a set of members;
a set of joints coupling the set of members; and
a controller configured to:
receive first image data from at least one sensor when the robot is in a first pose, wherein a first joint of the set of joints represented in the first image data has an expected joint position when the robot is in the first pose;
determine, based on the first image data, an actual joint position of the first joint when the robot is in the first pose; and
configure a first encoder of a first actuator associated with the first joint based, at least in part, on the actual joint position of the first joint when it is determined that the actual joint position of the first joint is different from the expected joint position of the first joint.

27-50. (canceled)

51. A controller for a robot, the controller configured to:
receive first image data from at least one sensor when the robot is in a first pose, wherein a first joint of the robot is represented in the first image data has an expected joint position when the robot is in the first pose;
determine, based on the first image data, an actual joint position of the first joint when the robot is in the first pose; and
configure a first encoder of a first actuator associated with the first joint based, at least in part, on the actual joint position of the first joint when it is determined that the actual joint position of the first joint is different from the expected joint position of the first joint.

52-75. (canceled)
